(19) United States
(12) Patent Application Publication
(10) Pub. No.: US 2014/0351758 A1
(43) Pub. Date: Nov. 27, 2014

(54) OBJECT SELECTING DEVICE

(71) Applicant: FUNAI ELECTRIC CO., LTD., Osaka (JP)

(72) Inventor: Hiroshi YOSHIDA, Osaka (JP)

(73) Assignee: FUNAI ELECTRIC CO., LTD., Osaka (JP)

(21) Appl. No.: 14/274,810

(22) Filed: May 12, 2014

(30) Foreign Application Priority Data
May 27, 2013 (JP) 2013-110511

(51) Int. Cl. G06F 3/0482; G06F 3/0481; G06F 3/0484; G06F 3/0488

(52) U.S. Cl. CPC G06F 3/0482; G06F 3/0488; G06F 3/04812; G06F 3/04842
USPC 715/823

(57) ABSTRACT

An object selecting device includes a display unit including a display screen that displays a plurality of objects; a touch panel; a candidate object extracting unit that, when the touch panel detects a touching operation using an indicator, extracts an object displayed within a predetermined range including a touch position as one or more candidate objects; a temporarily selected object extracting unit that, when the touch panel detects a sliding operation of the indicator on the touch panel, extracts one candidate object from among the candidate objects as a temporarily selected object; and a selecting unit that, when the selecting unit receives a determining operation by a user, selects the temporarily selected object as a selected object.

### CROSS REFERENCE TO RELATED APPLICATION

The present application is based on and claims priority of Japanese Patent Application No. 2013-110511 filed on May 27, 2013. The entire disclosure of the above-identified application, including the specification, drawings and claims is incorporated herein by reference in its entirety.

### FIELD

The present invention relates to an object selecting device that allows a user to select an object from among objects displayed on a display screen and, in particular, an object selecting device including a touch panel that receives a user's operation.

### BACKGROUND

Conventionally, when an object is selected in a figure drawing system capable of drawing and editing objects such as graphic information or textual information, a user moves a mouse, thereby moving a mouse pointer onto the object to be selected, and then clicks a mouse button. Further, the user drags the mouse so as to specify a range of objects to be selected (for example, see Patent Literature 1). When selecting a selectable place such as a link displayed on a web page during the execution of a web browser, the user moves the mouse pointer onto the link and click the mouse button, thereby specifying the link.

In such a situation, recent years have seen a widespread use of apparatuses such as a tablet terminal or a smartphone equipped with a touch panel. The user who uses these apparatuses can touch a display screen with an indicator such as a touch pen or a user's finger without using any input device such as a mouse, thereby selecting an object displayed on the display screen.

### CITATION LIST

### Patent Literature

[Patent Literature 1] Japanese Unexamined Patent Application Publication No. 2000-20741

### SUMMARY

### Technical Problem

However, the display screen of the tablet terminal or the smartphone is small, and the touch pen or the user's finger serving as the indicator has a certain thickness. This makes it difficult to specify positions precisely by using the indicator. In other words, it is difficult for the user to select a desired object by using the indicator. Especially when objects are densely located, the selection would become even more difficult.

Also, in order to select an object hidden behind another object, the user has to displace the latter so that the former can be seen, and then select this object. Therefore, an operation for selecting the object is complicated.

In order to solve the problems described above, it is an object of the present invention to provide an object selecting device capable of selecting a desired object with simple operations when the object is selected by a contact of an indicator.

### Solution to Problem

In order to achieve the above-mentioned object, an object selecting device according to one aspect of the present invention is an object selecting device that selects, as a selected object, one object from among a plurality of objects displayed on a display screen. The object selecting device includes a display unit including the display screen that displays the plurality of objects; a touch panel that is overlaid on the display screen and detects a touch position touched by a user using an indicator; a candidate object extracting unit that, when the touch panel detects a touching operation using the indicator, extracts, as one or more candidate objects, an object displayed within a predetermined range including the touch position from among the plurality of objects; a temporarily selected object extracting unit that, when the touch panel detects a sliding operation, extracts, as a temporarily selected object, one candidate object from among the candidate objects, the sliding operation being an operation of sliding the indicator on the touch panel, and displays the extracted temporarily selected object on the display screen in a mode distinguished from other candidate objects; and a selecting unit that, when the selecting unit receives a determining operation by the user, selects, as the selected object, the temporarily selected object extracted by the temporarily selected object extracting unit.

With this configuration, the candidate objects are extracted by touching the touch panel using the indicator, and then the user slides the indicator, whereby the temporarily selected object is extracted from among the candidate objects. Finally, the user carries out a determining operation, so that the temporarily selected object is selected as the selected object. In this manner, the user can select an object by carrying out a series of operations of touching and sliding the indicator and the determining operation. This makes it possible to select a desired object with simple operations.

For example, the candidate object extracting unit may further assign a sequence to the candidate objects, and the temporarily selected object extracting unit may, when the touch panel detects the sliding operation of the indicator, extract the temporarily selected object while changing the one candidate object to be extracted from among the candidate objects with a movement of the indicator in an ascending order or a descending order of the assigned sequence, the ascending order and the descending order each being associated with a sliding direction of the indicator.

With this configuration, as the user slides the indicator, the temporarily selected objects to be extracted are changed sequentially. Thus, a desired temporarily selected object can be extracted with a simple operation of stopping a sliding operation once the desired object is extracted. This makes it possible to select a desired object with simple operations.

Also, the candidate object extracting unit may assign the sequence to the candidate objects clockwise on the display screen, and the temporarily selected object extracting unit may, as the touch panel detects a clockwise sliding operation, sequentially extract the temporarily selected object clockwise on the display screen from among the candidate objects.

With this configuration, when the indicator is moved clockwise, the temporarily selected objects are extracted clockwise. In other words, a turning direction of the indicator and a direction of extracting the temporarily selected objects are matched. Thus, the user can extract the desired temporarily selected objects with simple and intuitive operations. This makes it possible to select a desired object with simple operations.

Further, the candidate object extracting unit may assign the sequence to the candidate objects counterclockwise on the display screen, and the temporarily selected object extracting unit may, as the touch panel detects a counterclockwise sliding operation, sequentially extract the temporarily selected object counterclockwise on the display screen from among the candidate objects.

With this configuration, when the indicator is moved counterclockwise, the temporarily selected objects are extracted counterclockwise. In other words, the turning direction of the indicator and the direction of extracting the temporarily selected objects are matched. Thus, the user can extract the desired temporarily selected objects with simple and intuitive operations. This makes it possible to select a desired object with simple operations.

Moreover, the temporarily selected object extracting unit may, when the touch panel detects the sliding operation of the indicator, extract, as the temporarily selected object, a candidate object displayed in a sliding direction of the indicator from among the candidate objects.

With this configuration, only by sliding the indicator toward a desired temporarily selected object, the user can extract that desired temporarily selected object. Thus, the user can extract the desired temporarily selected objects with simple and intuitive operations. This makes it possible to select a desired object with simple operations.

Additionally, the candidate object extracting unit may, when the touch panel detects the touching operation using the indicator, extract, as the one or more candidate objects, an object whose entire display region is included within a range at a certain distance from the touch position from among the plurality of objects.

With this configuration, it is possible to extract a candidate object from among objects located near the position touched using the indicator.

Also, the candidate object extracting unit may, when the touch panel detects the touching operation using the indicator, extract, as the one or more candidate objects, an object whose display region is at least partially included within a range at a certain distance from the touch position from among the plurality of objects.

With this configuration, it is possible to extract a candidate object from among objects located near the position touched using the indicator.

Moreover, the display screen may be sectioned into a plurality of areas, and the candidate object extracting unit may, when the touch panel detects the touching operation using the indicator, extract, as the one or more candidate objects, an object whose entire display region is included within an area including the touch position from among the plurality of objects.

With this configuration, it is possible to extract the candidate object located within the above-noted area.

Furthermore, the display screen may be sectioned into a plurality of areas, and the candidate object extracting unit may, when the touch panel detects the touching operation using the indicator, extract, as the one or more candidate objects, an object whose display region is at least partially included within an area including the touch position from among the plurality of objects.

With this configuration, even when an object is located across plural areas, it is possible to extract the candidate object from these areas.

Additionally, the temporarily selected object extracting unit may display on the display screen the extracted temporarily selected object in such a manner as to have different color, brightness, transparency, size, shape or texture from the other candidate objects.

With this configuration, the user can distinguish the extracted temporarily selected object from other objects.

Also, the temporarily selected object extracting unit may display the extracted temporarily selected object on the display screen in such a manner as to be rimmed.

With this configuration, the user can distinguish the extracted temporarily selected object from other objects.

Moreover, the temporarily selected object extracting unit may display the extracted temporarily selected object on the display screen in such a manner as to be in a foreground of a display tier.

With this configuration, the user can distinguish the extracted temporarily selected object from other objects.

Furthermore, when the selecting unit receives, as the determining operation, (i) an operation of moving the indicator off from the touch panel, (ii) a touching operation using the indicator at a single position for at least a certain period or (iii) an operation of depressing a predetermined button, the selecting unit may select, as the selected object, the temporarily selected object extracted by the temporarily selected object extracting unit.

With this configuration, the user can select an object with simple operations.

Additionally, the candidate object extracting unit may further display the candidate objects in a mode distinguished from other objects.

With this configuration, the user can recognize which is the candidate object.

It should be noted that the present invention can be realized not only as the object selecting device including the above-mentioned characteristic processing units but also as an object selecting method including, as steps, processes executed by the characteristic processing units included in the object selecting device. Also, the present invention can be realized as a program for causing a computer to function as the characteristic processing units included in the object selecting device or as a program for causing a computer to execute the characteristic steps included in the object selecting method. Then, it is needless to say that such a program can be distributed via a non-transitory computer readable recording medium such as a CD-ROM (Compact Disc-Read Only Memory) and a communication network such as the Internet.

### Advantageous Effects

According to the present invention, it is possible to provide an object selecting device capable of selecting a desired object with simple operations when the object is selected by a contact of an indicator.

### BRIEF DESCRIPTION OF DRAWINGS

These and other objects, advantages and features of the invention will become apparent from the following description thereof taken in conjunction with the accompanying drawings that illustrate a specific embodiment of the present invention.

[FIG. 1]

FIG. 1 illustrates an external appearance of a smartphone.

[FIG. 2]

FIG. 2 is a block diagram illustrating a main hardware configuration of the smartphone.

[FIG. 3]

FIG. 3 is a flowchart of processes executed by the smartphone.

[FIG. 4]

FIG. 4 is a drawing for describing a process of extracting candidate objects.

[FIG. 5]

FIG. 5 is a drawing for describing a process of extracting a temporarily selected object.

[FIG. 6]

FIG. 6 is a drawing for describing a flow of selecting an object during the execution of a figure drawing application.

[FIG. 7]

FIG. 7 is a drawing for describing a process of emphasizing the temporarily selected object.

[FIG. 8]

FIG. 8 is a drawing for describing a process of emphasizing the temporarily selected object.

[FIG. 9]

FIG. 9 is a drawing for describing a process of emphasizing the temporarily selected object.

[FIG. 10]

FIG. 10 is a drawing for describing a process of emphasizing the temporarily selected object.

[FIG. 11]

FIG. 11 is a drawing for describing a process of emphasizing the temporarily selected object.

[FIG. 12]

FIG. 12 is a drawing for describing a process of emphasizing the temporarily selected object.

[FIG. 13]

FIG. 13 is a drawing for describing a process of emphasizing the temporarily selected object.

[FIG. 14]

FIG. 14 is a drawing for describing a process of emphasizing the temporarily selected object.

[FIG. 15]

FIG. 15 is a drawing for describing a process of extracting the temporarily selected object.

[FIG. 16]

FIG. 16 is a drawing for describing a flow of selecting link information during the execution of a web browser.

[FIG. 17]

FIG. 17 is a drawing for describing a process of extracting a candidate object.

[FIG. 18]

FIG. 18 is a drawing for describing a process of extracting candidate objects.

[FIG. 19]

FIG. 19 is a drawing for describing a process of extracting candidate objects.

### DESCRIPTION OF EMBODIMENTS

The following is a detailed description of embodiments of the present invention, with reference to accompanying drawings. It should be noted that each of the embodiments described below will illustrate one specific example of the present invention. The numerical values, shapes, materials, structural components, the arrangement and connection of the structural components, steps and the order of the steps mentioned in the following embodiments are merely exemplary and not intended to limit the present invention. Among the structural components in the following embodiments, a structural component that is not recited in an independent claim will be described as an arbitrary structural component.

### Embodiment 1

### <Overall Configuration>

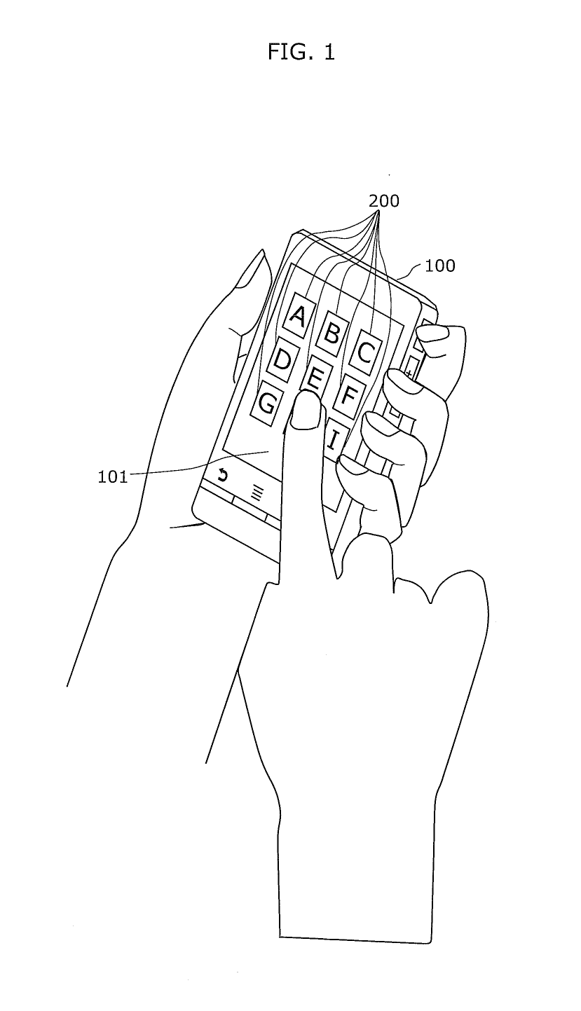

FIG. 1 illustrates an external appearance of a smartphone according to Embodiment 1.

A smartphone 100 is an example of the object selecting device. By a user's operation, the smartphone 100 selects, as a selected object, one object 200 from among a plurality of objects 200 displayed on a display screen 101. The user can select one object 200 displayed on the display screen 101 as the selected object by touching the display screen 101 with an indicator such as a finger or a touch pen. How to select the object 200 will be detailed later. Here, the object 200 is a user-selectable image such as a figure, text, an icon, a button and link information.

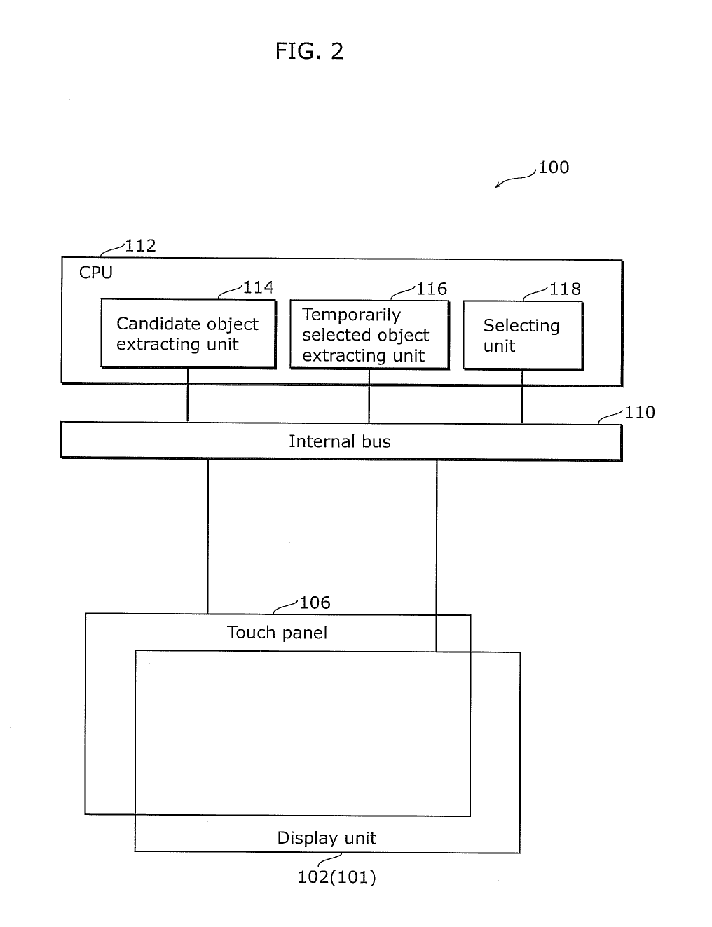

FIG. 2 is a block diagram illustrating a main hardware configuration of the smartphone 100.

The smartphone 100 includes a display unit 102, a touch panel 106, an internal bus 110 and a CPU 112.

The display unit 102 has, for example, the display screen 101 as shown in FIG. 1 and displays the plurality of objects 200 on the display screen 101. For example, the display unit 102 displays, on the display screen 101, a home screen in which icons serving as an example of the objects 200 are arranged. Also, the display unit 102 displays arranged figures serving as the exemplary objects 200 on the display screen 101 during the execution of a figure drawing application.

The touch panel 106 is a transparent device that is overlaid on the display screen 101 of the display unit 102. When the indicator makes contact with the touch panel 106, the touch panel 106 outputs coordinates of a position with which the indicator has made contact (a touch position).

The internal bus 110 interconnects the display unit 102, the touch panel 106 and the CPU 112.

The CPU 112 controls the smartphone 100. The CPU 112 includes a candidate object extracting unit 114, a temporarily selected object extracting unit 116 and a selecting unit 118 as functional processing units that are realized by executing a computer program.

When the touch panel 106 detects a touching operation using the indicator, the candidate object extracting unit 114 extracts, as candidate objects, the objects 200 displayed within a predetermined range including the touch position by the indicator from among the plurality of objects 200.

When the touch panel 106 detects a sliding operation, which is an operation of sliding the indicator on the touch panel 106, the temporarily selected object extracting unit 116 extracts one object from among the candidate objects as a temporarily selected object. Further, the temporarily selected object extracting unit 116 displays the extracted temporarily selected object on the display screen 101 of the display unit 102 in a mode distinguished from the other objects. The sliding operation includes, for example, a dragging operation of moving the indicator while keeping the contact between the indicator and the touch panel 106 and a flicking operation of swiping the indicator that has touched the touch panel 106. Although the dragging operation will be described as an example of the sliding operation in the following, the flicking operation instead of the dragging operation may be performed as the sliding operation.

When the selecting unit 118 receives the determining operation by the user, it selects, as a selected object, the temporarily selected object extracted by the temporarily selected object extracting unit 116. For example, when the selected object is a figure, the user can move the indicator, thereby moving the selected object. When the selected object is an icon, the CPU 112 executes a program associated with this icon. A specific example of the determining operation will be described later.

### <Description of Processes>

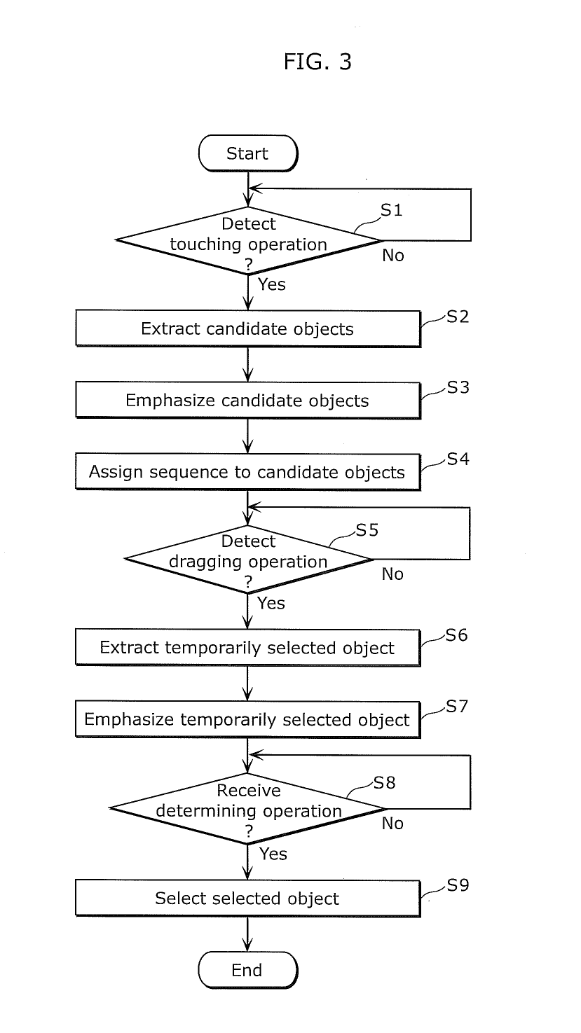

Hereinafter, referring to a specific example, processes executed by the smartphone 100 will be described. FIG. 3 is a flowchart of the processes executed by the smartphone 100. In the following description, the indicator that makes contact with the touch panel 106 is a user's finger. However, the indicator is not limited to the finger but may be the touch pen as described above.

The touch panel 106 waits until the user's finger touches the touch panel 106 (NO in S1). When the touch panel 106 detects the touching operation in which the finger makes contact with the touch panel 106 (YES in S1), it outputs the touch position and shifts to S2 (S1). The touch panel 106 outputs, as the touch position, the coordinates of the position on the touch panel 106 with which the finger has made contact.

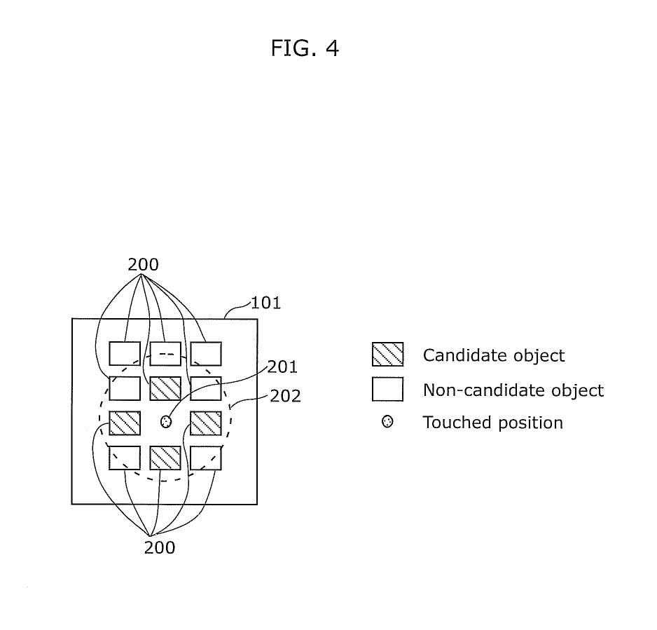

When the touch panel 106 detects the touching operation with the finger (YES in S1), the candidate object extracting unit 114 extracts, as the candidate objects, the objects displayed within a predetermined range including the touch position from among the plurality of objects displayed on the display screen 101 (S2). For example, it is now assumed that 11 objects 200 are arranged on the display screen 101 as shown in FIG. 4 and the user touches a touch position 201 near the center of the display screen 101. At this time, the candidate object extracting unit 114 extracts, as the candidate objects, the objects 200 whose entire display region is included within a range 202 at a certain distance from the touch position 201. In the example shown in FIG. 4, four hatched objects 200 are extracted as the candidate objects.

The candidate object extracting unit 114 causes the display unit 102 to emphasize the extracted candidate objects, thereby displaying the candidate objects in a mode distinguished from the other objects (S3). For example, in FIG. 4, the candidate objects are hatched so as to be emphasized.

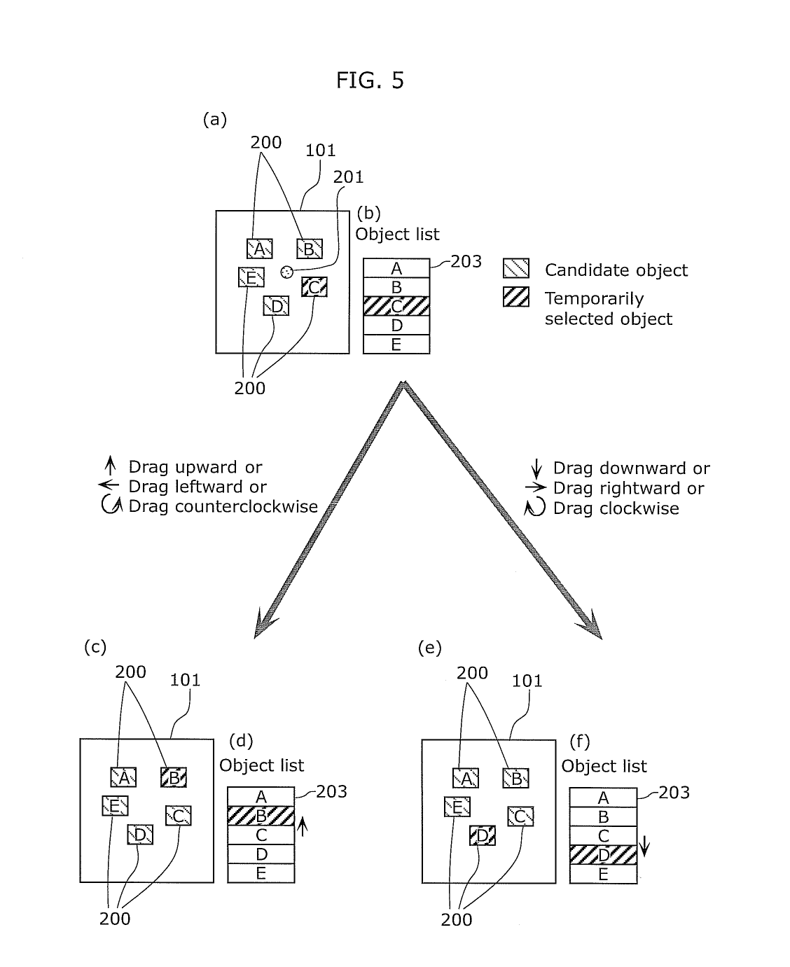

The candidate object extracting unit 114 assigns a sequence to the candidate objects (S4). For example, from among the objects displayed on the display screen 101, five objects 200 from A to E are extracted as the candidate objects as shown in (a) of FIG. 5. Hereinafter, these five objects 200 are referred to as objects A to E. In (a) of FIG. 5, only the candidate objects are shown, and the objects that are not extracted as candidates are omitted. The candidate object extracting unit 114 assigns a sequence to the objects A to E clockwise around the touch position 201. A list of the assigned sequence is shown in (b) of FIG. 5. As shown in a list 203, the candidate objects are assigned the sequence of A, B, C, D and E. Incidentally, the list 203 may be or need not be displayed on the display screen 101.

When the user carries out the dragging operation in this state (YES in S5), the temporarily selected object extracting unit 116 extracts, as the temporarily selected object, one candidate object while changing the one candidate object to be extracted from among the candidate objects in an ascending order or a descending order of the assigned sequence associated with the sliding direction of the finger (S6). Here, the objects are extracted in the ascending order when the sliding direction of the finger is upward, leftward or counterclockwise, whereas the objects are extracted in the descending order when the sliding direction of the finger is downward, rightward or clockwise. The temporarily selected object extracting unit 116 extracts the temporarily selected object while changing the objects every time a moving distance of the finger exceeds a certain distance, for example.

For instance, in (a) and (b) of FIG. 5, the object C that is closest to the touch position 201 is extracted as the temporarily selected object. When the user drags his/her finger upward, leftward or counterclockwise on the touch panel 106 in this state, the temporarily selected object extracting unit 116 extracts, as the temporarily selected object, the object B that features one rank higher than the object C as shown in (c) and (d) of FIG. 5. When the user slides his/her finger further in the same direction, the temporarily selected object extracting unit 116 extracts, as the temporarily selected object, the object A that features one rank higher than the object B. There is no candidate object that features higher than the object A. Accordingly, when the user slides his/her finger further in the same direction, the temporarily selected object extracting unit 116 may continue to extract the object A as the temporarily selected object or may extract the object E that is lowest in the order as the temporarily selected object.

Also, in the state shown in (a) and (b) of FIG. 5, when the user drags his/her finger downward, rightward or clockwise on the touch panel 106, the temporarily selected object extracting unit 116 extracts, as the temporarily selected object, the object D that features one rank lower than the object C as shown in (e) and (f) of FIG. 5. Thereafter, as the user slides his/her finger in the same direction, the temporarily selected object is extracted in the descending order. There is no candidate object that features lower than the object E. Accordingly, when the user slides his/her finger further in the same direction while the object E is extracted as the temporarily selected object, the temporarily selected object extracting unit 116 may continue to extract the object E as the temporarily selected object or may extract the object A that is highest in the order as the temporarily selected object.

The temporarily selected object extracting unit 116 displays the extracted temporarily selected object on the display screen 101 in a mode distinguished from the other objects. For example, in (c) of FIG. 5, the object B serving as the temporarily selected object is hatched differently from the other objects A, C, D and E.

When the smartphone 100 receives the determining operation by the user (YES in S8), the selecting unit 118 selects, as the selected object, the temporarily selected object that is extracted at that time (S9). The determining operation is not particularly limited but can be, for example, an operation of moving the finger off from the touch panel 106, an operation of touching a single position on the touch panel 106 for at least a certain period or an operation of depressing a predetermined software button provided in the display screen 101 or a predetermined hardware button provided in the smartphone 100. For example, when the user moves his/her finger off from the display screen 101 while the object B is extracted as the temporarily selected object as shown in (c) of FIG. 5, the selecting unit 118 selects the object B as the selected object.

By a series of operations described above, the user can select one object from among a plurality of objects.

### SPECIFIC EXAMPLE

As a specific example of the above-described operations executed by the smartphone 100, an operation of selecting an object during the execution of the figure drawing application will be described in the following.

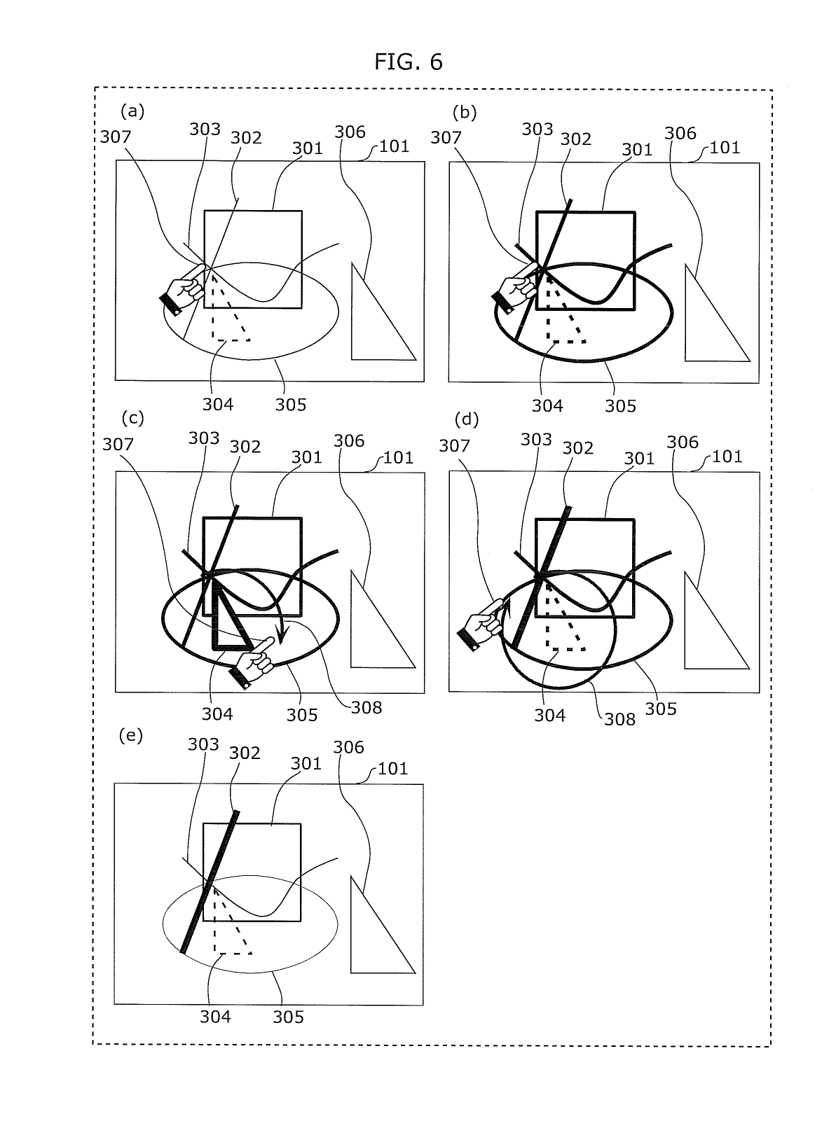

As shown in (a) of FIG. 6, objects 301 to 306, which are figures, are displayed on the display screen 101. It is noted that the object 304 is indicated by a dashed line since it is hidden behind the objects 301 and 305 and cannot be seen. When the user touches a touch position 307 on the display screen 101 with his/her finger, the objects 301 to 305 located within a range at a certain distance from the touch position 307 are extracted as the candidate objects (S2 in FIG. 3), which are displayed in such a manner as to be rimmed with a thick line as shown in (b) of FIG. 6 (S3 in FIG. 3).

As shown in (c) of FIG. 6, when the user drags his/her finger in a clockwise direction 308 in that state, one object 304 among the candidate objects is extracted as the temporarily selected object. At this time, the object 304 is arranged in a foreground of a display tier and displayed in such a manner as to be rimmed with a line even thicker than those for the other candidate objects (S7 in FIG. 3).

As shown in (d) of FIG. 6, when the user further drags his/her finger in the clockwise direction 308, another object 302 is selected as the candidate object. At this time, the object 302 is displayed in the foreground of the display tier and displayed in such a manner as to be rimmed with a line even thicker than those for the other candidate objects (S7 in FIG. 3).

As shown in (e) of FIG. 6, when the user moves his/her finger off from the touch panel 106 in that state, the object 302 that is currently extracted as the temporarily selected object is selected as the selected object. Thereafter, the user can move the position of the object 302 in a dragging direction by dragging his/her finger on the touch panel 106 and enlarge or reduce the object 302 by performing a pinch-out operation or a pinch-in operation with two fingers.

### <Other Display Modes of Temporarily Selected Object>

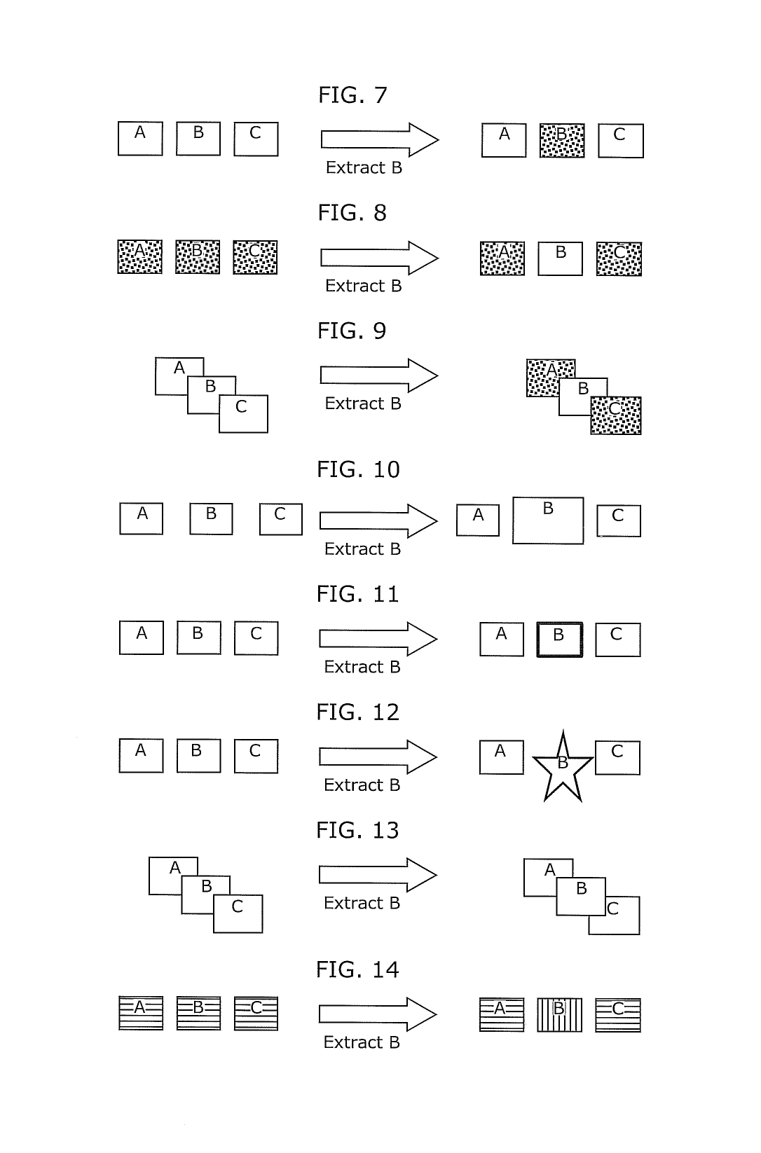

In the process of emphasizing the temporarily selected object (S7 in FIG. 3), the temporarily selected object has been displayed in such a manner as to be hatched differently from the other candidate objects (see FIG. 5). The method of emphasizing the temporarily selected object is not limited to this. For example, when the object B is extracted as the temporarily selected object from among the objects A to C as shown in FIG. 7, the object B may be displayed in such a manner as to have a different color from the objects A and C. Also, as shown in FIG. 8, the object B may be displayed in such a manner as to have different brightness from the objects A and C. Moreover, as shown in FIG. 9, the object B may be displayed in such a manner as to have a lower transparency than the objects A and C. Further, as shown in FIG. 10, the object B may be displayed in such a manner as to have a larger size than the objects A and C. Moreover, as shown in FIG. 11, the object B may be displayed in such a manner as to be rimmed. Also, as shown in FIG. 12, the object B may be displayed in such a manner as to have a different shape from the objects A and C. Furthermore, as shown in FIG. 13, the object B may be displayed in the foreground of the display tier. Additionally, as shown in FIG. 14, the object B may be displayed in such a manner as to have a different texture from the objects A and C.

Incidentally, the methods of emphasizing the temporarily selected object shown in FIGS. 7 to 14 may be used in the process of emphasizing the candidate objects (S3 in FIG. 3).

### <Advantageous Effects>

As described above, in accordance with Embodiment 1, the candidate objects are extracted by touching the touch panel 106 using the indicator, and then the user slides the indicator, whereby the temporarily selected object is extracted from among the candidate objects. Finally, the user carries out the determining operation, so that the temporarily selected object is selected as the selected object. In this manner, the user can select an object by carrying out a series of operations of touching and sliding the indicator and the determining operation. This makes it possible to select a desired object with simple operations. Especially when it is difficult to touch the object using the indicator because the objects are overlapped, the desired object can be selected with simple operations.

Incidentally, as the user slides the indicator, the temporarily selected objects to be extracted are changed sequentially. Thus, a desired temporarily selected object can be extracted with the simple operation of stopping the sliding operation once the desired object is extracted. This makes it possible to select the desired object with simple operations.

In particular, the temporarily selected objects are extracted clockwise when the indicator is moved clockwise, whereas the temporarily selected objects are extracted counterclockwise when the indicator is moved counterclockwise. In other words, the turning direction of the indicator and the direction of extracting the temporarily selected objects are matched. Thus, the user can extract the desired temporarily selected objects with simple and intuitive operations. This makes it possible to select the desired object with simple operations.

### Embodiment 2

A smartphone according to Embodiment 2 will be described. The overall configuration and the process flow of the smartphone according to Embodiment 2 are similar to those in Embodiment 1. However, a process of extracting a temporarily selected object (S6 in FIG. 3) is different from that in Embodiment 1. The following description will be directed to the process of extracting the temporarily selected object (S6 in FIG. 3), and the description of the configuration and processes similar to those in Embodiment 1 will not be repeated.

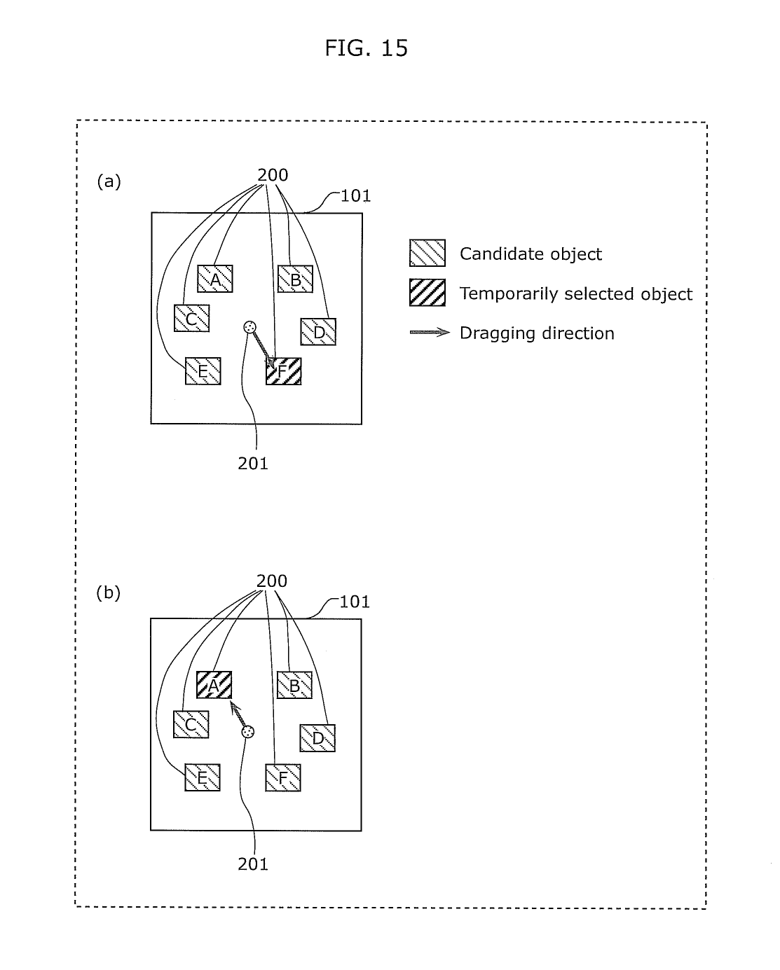

FIG. 15 is a drawing for describing the process of extracting the temporarily selected object (S6 in FIG. 3). As shown in (a) of FIG. 15, among the objects displayed on the display screen 101, six objects 200 from A to F are extracted as the candidate objects. Hereinafter, these six objects 200 are referred to as objects A to F. Incidentally, (a) of FIG. 15 shows only the candidate objects, and the objects that are not extracted as candidates are omitted. Now, the user carries out the dragging operation from the touch position 201 in a direction indicated by an arrow (a dragging direction). At this time, the temporarily selected object extracting unit 116 extracts, as the temporarily selected object, the object F located along an extension line of the dragging direction. Similarly, as shown in (b) of FIG. 15, the user carries out the dragging operation from the touch position 201 in a direction indicated by an arrow (a dragging direction). At this time, the temporarily selected object extracting unit 116 extracts, as the temporarily selected object, the object A located along an extension line of the dragging direction.

### SPECIFIC EXAMPLE

In the following, a flow of selecting an object will be described referring to an example of selecting link information (one kind of the object) during the execution of a web browser

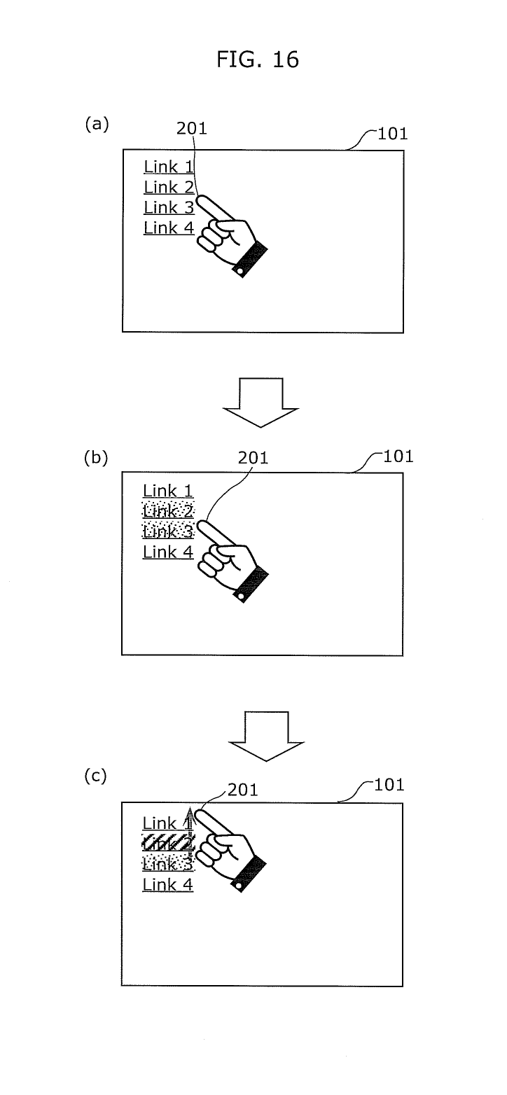

As shown in (a) of FIG. 16, the link information (links 1 to 4), which is one kind of the object, is displayed on the display screen 101. When the user touches the touch position 201 on the display screen 101 with his/her finger, the link 2 and the link 3 that are located within a range at a certain distance from the touch position 201 are extracted as the candidate objects (S2 in FIG. 3) and hatched so as to be emphasized as shown in (b) of FIG. 16 (S3 in FIG. 3).

As shown in (c) of FIG. 16, when the user drags his/her finger in a direction indicated by an arrow in this state, the link 2 located in the dragging direction is extracted as the temporarily selected object. At this time, the link 2 is hatched differently from the link 3 so as to be emphasized (S7 in FIG. 3). When the user moves his/her finger off from the touch panel 106 in this state, the link 2 that is currently extracted as the temporarily selected object is selected. Thereafter, the display is switched to a web page corresponding to URL (Uniform Resource Locator) indicated by the link 2.

### <Advantageous Effects>

As described above, according to Embodiment 2, only by sliding the finger toward a desired temporarily selected object, the user can extract that desired temporarily selected object. Thus, the user can extract the desired temporarily selected objects with simple and intuitive operations. This makes it possible to select the desired object with simple operations.

### Embodiment 3

A smartphone according to Embodiment 3 will be described. The overall configuration and the process flow of the smartphone according to Embodiment 3 are similar to those in Embodiment 1. However, a process of extracting a candidate object (S2 in FIG. 3) is different from that in Embodiment 1. The following description will be directed to the process of extracting the candidate object (S2 in FIG. 3), and the description of the configuration and processes similar to those in Embodiment 1 will not be repeated.

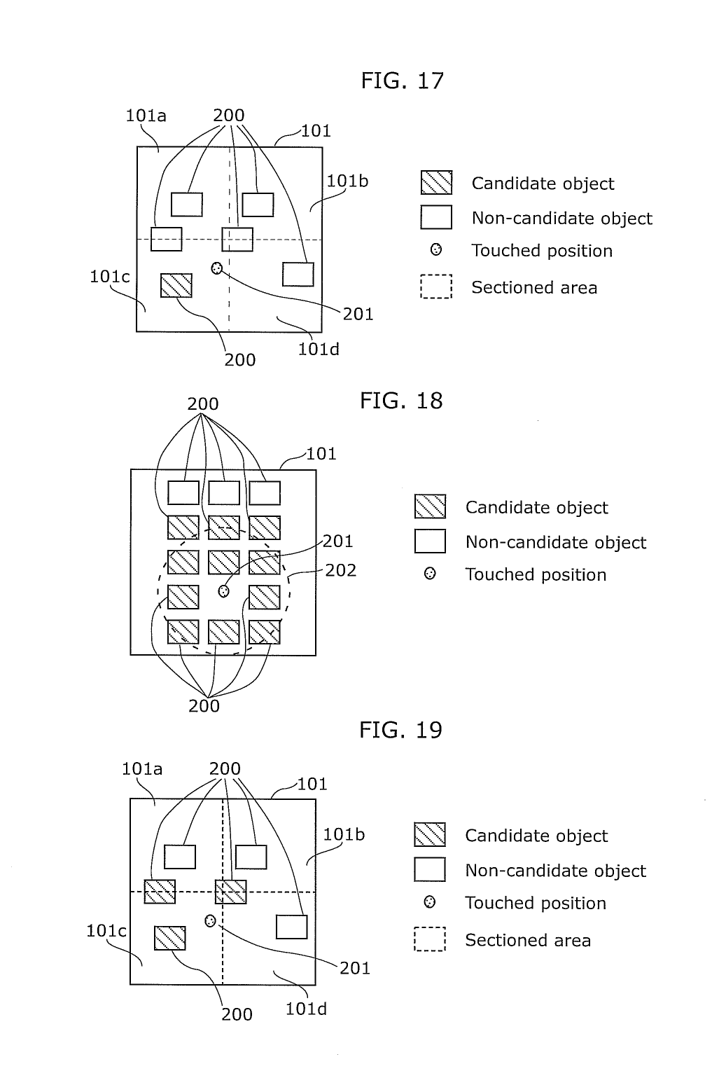

FIG. 17 is a drawing for describing the process of extracting the candidate object (S2 in FIG. 3). As shown in FIG. 17, the display screen 101 is sectioned into four areas 101a to 101d in advance. Also, six objects 200 are arranged on the display screen 101, and the user touches the touch position 201 near the center of the display screen 101 with his/her finger. At this time, the candidate object extracting unit 114 extracts, as the candidate object, the object 200 whose entire display region is included within the area 101c including the touch position 201. In the example of FIG. 17, one hatched object 200 is extracted as the candidate object.

As described above, according to Embodiment 3, it is possible to extract the candidate object located in each of the areas. For example, Embodiment 3 is effective when a group of objects is arranged in each area.

Although the object selecting device according to the present invention has been described above referring to the embodiments, the present invention is not limited to these embodiments.

For example, in Embodiment 1, the objects 200 whose entire display region is included within the range 202 at a certain distance from the touch position 201 are extracted as the candidate objects as shown in FIG. 4. However, the method of extracting the candidate object is not limited to this. For example, as shown in FIG. 18, the candidate object extracting unit 114 may extract, as the candidate object, the objects 200 whose display region is at least partially included within the range 202 at a certain distance from the touch position 201. In the example of FIG. 18, 11 hatched objects 200 are extracted as the candidate objects.

Further, in Embodiment 3, the object 200 whose entire display region is included within the area including the touch position 201 is extracted as the candidate object as shown in FIG. 17. However, the method of extracting the candidate object is not limited to this. For example, as shown in FIG. 19, the candidate object extracting unit 114 may extract, as the candidate objects, the objects 200 whose display region is at least partially included within the area 101c including the touch position 201. In the example of FIG. 19, three hatched objects 200 are extracted as the candidate objects.

Moreover, Embodiment 1 has assigned the sequence to the objects clockwise around the touch position 201 as shown in FIG. 5. However, the method of assigning the sequence to the objects is not limited to this. For example, it may be possible to assign the sequence to the objects counterclockwise around the touch position 201 or to assign the sequence to the objects from the one closest to the touch position 201.

Further, the object selecting device described above is not limited to the smartphone but may be a tablet terminal. Also, the object selecting device described above may be configured as a computer system constituted by a microprocessor, a ROM, a RAM, a hard disk drive, a display unit, a keyboard, a mouse and so on. The RAM or the hard disk drive stores a computer program. The microprocessor operates according to the computer program, whereby each device achieves its function. Here, the computer program is configured by combining a plurality of instruction codes issuing a command to a computer for achieving a predetermined function.

Moreover, part or all of the structural components constituting each of the devices described above may be configured by a single system LSI (Large Scale Integration). The system LSI is a super-multifunctional LSI manufactured by integrating a plurality of structural parts on a single chip and, more specifically, is a computer system constituted by including a microprocessor, a ROM, a RAM and so on. The RAM stores a computer program. The microprocessor operates according to the computer program, whereby the system LSI achieves its function.

Furthermore, part or all of the structural components constituting each of the devices described above may be configured by an IC card, which can be attached to and detached from each of the devices, or a stand-alone module. The IC card or the module is a computer system configured by a microprocessor, a ROM, a RAM and so on. The IC card or the module may include the ultra-multifunctional LSI mentioned above. The microprocessor operates according to the computer program, whereby the IC card or the module achieves its function. This IC card or module may have a tamper resistance.

The present invention may be the method described above. Also, the present invention may be a computer program that realizes the method by a computer or may be a digital signal made of such a computer program.

Further, the present invention may be achieved by recording the computer program or the digital signal mentioned above in a non-transitory computer-readable recording medium, for example, a flexible disk, a hard disk, a CD-ROM, an MO, a DVD, a DVD-ROM, a DVD-RAM, a BD (Blu-ray (registered trademark) Disc), a semiconductor memory or the like. Additionally, the present invention may be the above-noted digital signal that is recorded in such a non-transitory recording medium.

Moreover, the present invention may transmit the computer program or the digital signal mentioned above via a telecommunication line, a wireless or wired communication line, a network represented by the Internet, a data broadcasting or the like.

Also, the present invention may be a computer system including a microprocessor and a memory, the above-noted memory may store the computer program mentioned above, and the above-noted microprocessor may operate according to the computer program mentioned above.

Further, by recording the program or the digital signal mentioned above in the above-noted non-transitory recording medium and transferring it or by transferring the program or the digital signal mentioned above via the above-noted network or the like, the present invention may be implemented with another independent computer system.

Moreover, the above-described embodiments and the above-described variations may be combined individually.

Although only some exemplary embodiments of the present invention have been described in detail above, those skilled in the art will readily appreciate that many modifications are possible in the exemplary embodiments without materially departing from the novel teachings and advantages of the present invention. Accordingly, all such modifications are intended to be included within the scope of the present invention.

### INDUSTRIAL APPLICABILITY

As the object selecting device, the present invention is applicable to a smartphone or a tablet terminal equipped with a touch panel, for example.

1. An object selecting device that selects, as a selected object, one object from among a plurality of objects displayed on a display screen, the object selecting device comprising:
a display unit including the display screen that displays the plurality of objects;
a touch panel that is overlaid on the display screen and detects a touch position touched by a user using an indicator;
a candidate object extracting unit configured to, when the touch panel detects a touching operation using the indicator, extract, as one or more candidate objects, an object displayed within a predetermined range including the touch position from among the plurality of objects;
a temporarily selected object extracting unit configured to, when the touch panel detects a sliding operation, extract, as a temporarily selected object, one candidate object from among the candidate objects, the sliding operation being an operation of sliding the indicator on the touch panel, and to display the extracted temporarily selected object on the display screen in a mode distinguished from other candidate objects; and
a selecting unit configured to, when the selecting unit receives a determining operation by the user, select, as the selected object, the temporarily selected object extracted by the temporarily selected object extracting unit.

2. The object selecting device according to claim 1,
wherein the candidate object extracting unit is further configured to assign a sequence to the candidate objects, and
the temporarily selected object extracting unit is configured to, when the touch panel detects the sliding operation of the indicator, extract the temporarily selected object while changing the one candidate object to be extracted from among the candidate objects with a movement of the indicator in an ascending order or a descending order of the assigned sequence, the ascending order and the descending order each being associated with a sliding direction of the indicator.

3. The object selecting device according to claim 2,
wherein the candidate object extracting unit is configured to assign the sequence to the candidate objects clockwise on the display screen, and
the temporarily selected object extracting unit is configured to, as the touch panel detects a clockwise sliding operation, sequentially extract the temporarily selected object clockwise on the display screen from among the candidate objects.

4. The object selecting device according to claim 2,
wherein the candidate object extracting unit is configured to assign the sequence to the candidate objects counterclockwise on the display screen, and
the temporarily selected object extracting unit is configured to, as the touch panel detects a counterclockwise sliding operation, sequentially extract the temporarily selected object counterclockwise on the display screen from among the candidate objects.

5. The object selecting device according to claim 1,
wherein the temporarily selected object extracting unit is configured to, when the touch panel detects the sliding operation of the indicator, extract, as the temporarily selected object, a candidate object displayed in a sliding direction of the indicator from among the candidate objects.

6. The object selecting device according to claim 1,
wherein the candidate object extracting unit is configured to, when the touch panel detects the touching operation using the indicator, extract, as the one or more candidate objects, an object whose entire display region is included within a range at a certain distance from the touch position from among the plurality of objects.

7. The object selecting device according to claim 1,
wherein the candidate object extracting unit is configured to, when the touch panel detects the touching operation using the indicator, extract, as the one or more candidate objects, an object whose display region is at least partially included within a range at a certain distance from the touch position from among the plurality of objects.

8. The object selecting device according to claim 1,
wherein the display screen is sectioned into a plurality of areas, and
the candidate object extracting unit is configured to, when the touch panel detects the touching operation using the indicator, extract, as the one or more candidate objects, an object whose entire display region is included within an area including the touch position from among the plurality of objects.

9. The object selecting device according to claim 1,
wherein the display screen is sectioned into a plurality of areas, and
the candidate object extracting unit is configured to, when the touch panel detects the touching operation using the indicator, extract, as the one or more candidate objects, an object whose display region is at least partially included within an area including the touch position from among the plurality of objects.

10. The object selecting device according to claim 1,
wherein the temporarily selected object extracting unit is configured to display on the display screen the extracted temporarily selected object in such a manner as to have different color, brightness, transparency, size, shape or texture from the other candidate objects.

11. The object selecting device according to claim 1,
wherein the temporarily selected object extracting unit is configured to display the extracted temporarily selected object on the display screen in such a manner as to be rimmed.

12. The object selecting device according to claim 1,
wherein the temporarily selected object extracting unit is configured to display the extracted temporarily selected object on the display screen in such a manner as to be in a foreground of a display tier.

13. The object selecting device according to claim 1,
wherein, when the selecting unit receives, as the determining operation, (i) an operation of moving the indicator off from the touch panel, (ii) a touching operation using the indicator at a single position for at least a certain period or (iii) an operation of depressing a predetermined button, the selecting unit is configured to select, as the selected object, the temporarily selected object extracted by the temporarily selected object extracting unit.

14. The object selecting device according to claim 1,
wherein the candidate object extracting unit is further configured to display the candidate objects in a mode distinguished from other objects.
